(19) United States
(12) Patent Application Publication
(10) Pub. No.: US 2014/0156146 A1
(43) Pub. Date: Jun. 5, 2014

(54) EXTERNAL AIRBAG DEPLOYMENT SYSTEM AND METHOD

(71) Applicant: HYUNDAI MOTOR COMPANY, Seoul (KR)

(72) Inventors: Han Sung Lee, Seoul (KR); Seoung Hoon Lee, Suwon (KR); Yong Sun Kim, Namyangju (KR); Sang Min Jo, Jeonju (KR); Jin Ho Bae, Suwon (KR)

(73) Assignee: HYUNDAI MOTOR COMPANY, Seoul (KR)

(21) Appl. No.: 13/846,460

(22) Filed: Mar. 18, 2013

(30) Foreign Application Priority Data
Dec. 4, 2012 (KR) 10-2012-0139524

(51) Int. Cl. B60R 21/0132

(52) U.S. Cl. CPC B60R 21/0132
USPC 701/45

(57) ABSTRACT

Disclosed herein is an external airbag deployment method and system. In the method, a detection area located in front of a vehicle is set. A target object is selected from a plurality of objects detected in the detection area by comparing a relative velocity, an overlap, and a TTE, which is a remaining time until each object collides with an airbag cushion when an external airbag is predicted to be deployed. The method further includes determining whether the vehicle is stable by comparing a predicted yaw rate of the vehicle with a measured yaw rate and determining whether a relative velocity and an overlap, predicted at a time when the target object is predicted to collide with the vehicle, are greater than predetermined levels. The external airbag is deployed when the vehicle is stable, and the predicted relative velocity and overlap are greater than the predetermined levels.

### CROSS-REFERENCE TO RELATED APPLICATION

This application claims under 35 U.S.C. §119(a) the benefit of Korean Patent Application No. 10-2012-0139524 filed on Dec. 4, 2012 the entire contents of which are incorporated herein by reference.

### BACKGROUND OF THE INVENTION

1. Field of the Invention

The present invention relates, in general, to an external air bag deployment method for a to vehicle, which is configured to predict a potential collision and deploy an external airbag at the time of the collision based on the results of the prediction, without causing false operation.

More particularly, the present invention relates to an external airbag deployment method, which may be configured to deploy an external airbag after determining the traction stability of an autonomous vehicle, physical quantities when a collision is predicted to occur, collision probability, and avoidance possibility, thus reducing the possibility of false deployment that may deteriorate the characteristics of the external airbag, and increasing the reliability of an airbag system.

2. Description of the Related Art

Recently, an external airbag that is outwardly deployed from the front or rear side of a vehicle has been developed and presented as a technology for improving vehicle safety. This technology is configured to deploy an external airbag by detecting and predicting a vehicle collision. However, in this technology maximum shock absorption effects must be obtained by deploying the external airbag at a precise time of the collision, and stability must be improved by correctly deploying the external airbag at a time point at which the airbag must be deployed, and system reliability must be improved by preventing the airbag from being falsely deployed at a time point at which the airbag must not be deployed.

A conventional method of controlling an airbag module using information obtained prior to a collision includes detecting information regarding an object located in front of a vehicle using an ultrasonic sensor and radar sensor mounted in the vehicle; comparing information regarding a distance to the object detected by the ultrasonic sensor with information about a distance to the object detected by the radar sensor; selecting at least one of the information regarding the object detected by the ultrasonic sensor and the information regarding the same object detected by the radar sensor based on the results of the comparison of the distance information, and determining whether the object is located in an area when there is a possibility that the object may collide with the vehicle, based on the selected information; and deploying an airbag module installed within the vehicle, based on the results of the determination of whether the object is located in the area where there is a possibility that the object may collide with the vehicle.

The foregoing is intended merely to aid in the better understanding of the background of the present invention, and is not intended to mean that the present invention falls within the purview of the related art that is already known to those skilled in the art.

### SUMMARY OF THE INVENTION

Accordingly, the present invention provides an external airbag deployment method, which is implemented in a vehicle and is configured to predict a potential collision and deploy an external airbag at a substantially precise time based on the results of the prediction, without causing false operation.

The present invention provides an external airbag deployment method including setting a detection area located in front of a vehicle; selecting a target object from a plurality of objects detected in the detection area by comparing a relative velocity, an overlap, and a Time To External Airbag (EAB) (TIE), which is a remaining time until each object collides with an airbag cushion when an external airbag is assumed to be deployed; determining whether the vehicle is stable by comparing a predicted yaw rate of the vehicle with a measured yaw rate; determining whether a relative velocity and an overlap, predicted at a time when the target object is assumed to collide with the vehicle, are greater than predetermined levels; and deploying the external airbag when the vehicle is stable, and the predicted relative velocity and overlap of the target object are greater than the predetermined levels.

Furthermore, the selecting process may include selecting a detected object as the target object when the detected object has a relative velocity greater than a first reference value, an overlap greater than a second reference value, and a TTE less than a third reference value. Additionally, the predetermined levels at may be the first reference value for the relative velocity and the second reference value for the overlap. Specifically, the first reference value may be selected from a range between 40 km/h and 50 km/h and the second reference value may be selected from a range between 10% and 30%. In addition, the third reference value may be selected from a range between 70 ms and 90 ms.

Moreover, the process of determining whether the relative velocity and the overlap are greater than predetermined levels may include determining whether collision probability based on a reciprocal of a Time To Collision (TTC) and a variation in the collision probability are greater than predetermined levels, wherein the TTC is a remaining time until a vehicle collision occurs when the collision is predicted to occur. Additionally, the process of deploying the airbag may include deploying the external airbag when the vehicle is stable, the predicted relative velocity and overlap of the target object are greater than the predetermined levels, and the collision probability and the variation in the collision probability are greater than the predetermined levels.

Furthermore, the process of determining whether the relative velocity and the overlap are greater than predetermined levels may include calculating a required steering avoidance distance and a required braking avoidance distance based on a relative velocity of the target object, and comparing a distance to the target object with the required steering avoidance distance and the required braking avoidance distance. Additionally, the process of deploying the airbag may include deploying the external airbag when the vehicle is stable, the predicted relative velocity and overlap of the target object are greater than the predetermined levels, and the distance to the target object is less than the required steering avoidance distance and the required braking avoidance distance.

Further, the present invention provides an external airbag deployment method of determining, by a processor, whether to deploy an external airbag, wherein a detection area having a predetermined range is set, and a target object is selected from a plurality of objects detected in the detection area by comparing a relative velocity, an overlap, and a Time To External Airbag (EAB) (TTE), which is a remaining time until each object collides with an airbag cushion when the external airbag is predicted to be deployed, and determining vehicle stability by comparing, by the processor, a predicted yaw rate of the vehicle with a measured yaw rate, determining, by the processor, whether a relative velocity and an overlap, predicted at a time when the target object is assumed to collide with the vehicle, are greater than predetermined levels, and deploying the external airbag when the vehicle is stable, and the predicted relative velocity and overlap of the target object are greater than the predetermined levels.

### BRIEF DESCRIPTION OF THE DRAWINGS

The above and other objects, features and advantages of the present invention will be more clearly understood from the following detailed description taken in conjunction with the accompanying drawings, in which:

FIG. 1 is an exemplary flowchart showing an external airbag deployment method according to an exemplary embodiment of the present invention;

FIGS. 2 and 3 are exemplary diagrams showing the detection area of the external airbag deployment method according to an exemplary embodiment of the present invention;

FIG. 4 is an exemplary diagram showing the prediction procedure of the external airbag deployment method according to an exemplary embodiment of the present invention;

FIG. 5 is an exemplary diagram showing the overlap determination of the external airbag deployment method according to an exemplary embodiment of the present invention;

FIGS. 6 and 7 are exemplary diagrams showing time to collision (TTC) and time to external airbag (TTE) of the external airbag deployment method according to an exemplary embodiment of the present invention;

FIG. 8 is an exemplary diagram showing the stability determination step of the external airbag to deployment method according to an exemplary embodiment of the present invention;

FIGS. 9 and 10 are exemplary diagrams showing the prediction step of the external airbag deployment method according to an exemplary embodiment of the present invention; and

FIGS. 11 to 13 are exemplary diagrams showing the avoidance step of the external airbag deployment method according to an exemplary embodiment of the present invention.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

Furthermore, control logic of the present invention may be embodied as non-transitory computer readable media on a computer readable medium containing executable program instructions executed by a processor, controller or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/of” includes any and all combinations of one or more of the associated listed items.

Hereinafter, embodiments of an external airbag deployment method according to the present invention will be described in detail with reference to the accompanying drawings.

Reference now should be made to the drawings, in which the same reference numerals are used throughout the different drawings to designate the same or similar components.

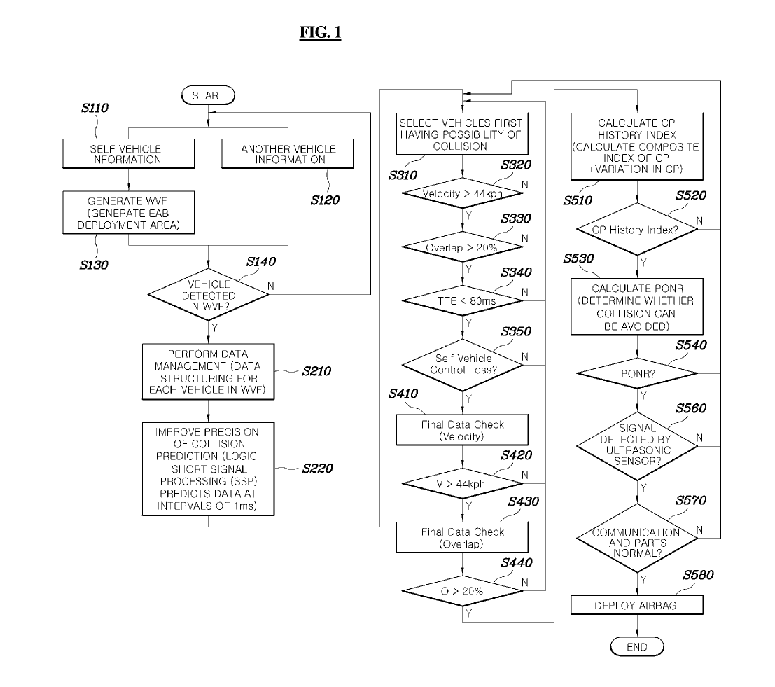

FIG. 1 is an exemplary flowchart showing an external airbag deployment method according to an exemplary embodiment of the present invention.

The external airbag deployment method according to the present invention may include setting, by a controller, a detection area located in front of a vehicle; selecting, by the controller, a target object from a plurality of objects detected in the detection area by comparing a relative velocity, an overlap, and a Time To External Airbag (EAB) (TTE), which is the remaining time until each object collides with an airbag cushion when the external airbag is predicted to be deployed; determining, by the controller, whether the vehicle is stable by comparing the predicted yaw rate of the vehicle with a measured yaw rate; determining whether a relative velocity and an overlap, predicted at a time when the target object is predicted to collide with the vehicle, are greater than predetermined levels; and deploying, by the controller, the external airbag when the vehicle is stable, and the predicted relative velocity and overlap of the target object are greater than the predetermined levels.

Additionally, the present invention provides an external airbag deployment system configured to deploy an external airbag after determining the traction stability of an autonomous vehicle, physical quantities at a time when a vehicle collision is predicted to occur, collision probability, and avoidance possibility, thus reducing the possibility of false deployment that may deteriorate the characteristics of the external airbag, and increasing the reliability of the external airbag system.

An embodiment of the overall deployment including the external airbag deployment method of the present invention will be described below.

Moreover information regarding an autonomous vehicle may be obtained (S110 and S120) through sensors configured to measure various aspects of the vehicle as shown in Table 1 below. Additionally, information regarding other objects may be measured using sensors, such as a laser sensor, a radar sensor, and an imaging device disposed in the vehicle, as shown in Table 2.

In detail, the information about the autonomous vehicle obtained by the sensors is given as follows.

TABLE 1

| Sensor | No | Information transferred to ACU |
|---|---|---|
| Vehicle velocity | 1 | FL(Front left) wheel speed |
| sensor | 2 | FR (Front right) wheel speed |
| | 3 | RL (Rear Left) wheel speed |
| | 4 | RR (Rear Right) wheel speed |
| Brake sensor | 5 | M/Cylinder pressure (MPa) |
| | 6 | Wheel slip ratio |
| | 7 | |
| | 8 | |
| Acceleration sensor | 9 | Longitudinal acceleration |
| | 10 | Lateral acceleration |
| Yaw rate sensor | 11 | Yaw rate (rad/sec) |
| | 12 | |
| Wheel angle sensor | 13 | Steering wheel angle |
| | 14 | |

Additionally, information about another object, obtained by the sensors, is given as follows.

TABLE 2

| Sensor | No | Information transferred to ACU |
|---|---|---|
| Radar (40 ms) | 1 | Relative velocity |
| | 2 | Relative distance |
| | 3 | Longitudinal position |
| | 4 | Lateral position |
| | 5 | Tracking ID |
| | 6 | TTC (time to collision) |
| Camera (80 ms) | 7 | Classification information |
| | 8 | Object width |
| | 9 | Longitudinal position |
| | 10 | Lateral position |
| | 11 | |
| | 12 | |
| | 13 | |
| | 14 | |
| Ultrasonic (10 ms) | 15 | Relative distance |
| | 16 | |

TABLE 3

| No | Information transferred to ACU |
|---|---|
| 1 | Object ID |
| 2 | Position X |
| 3 | Position Y |
| 4 | Velocity X |
| 5 | Velocity Y |
| 6 | Object age |
| 7 | Object prediction age |
| 8 | Object time offset |
| 9 | Object classification |

Furthermore, using the information obtained by the sensors, the controller disposed in the vehicle may obtain relative information and absolute information regarding the vehicle and the other object. The information obtained by the controller is show in Table 3 above.

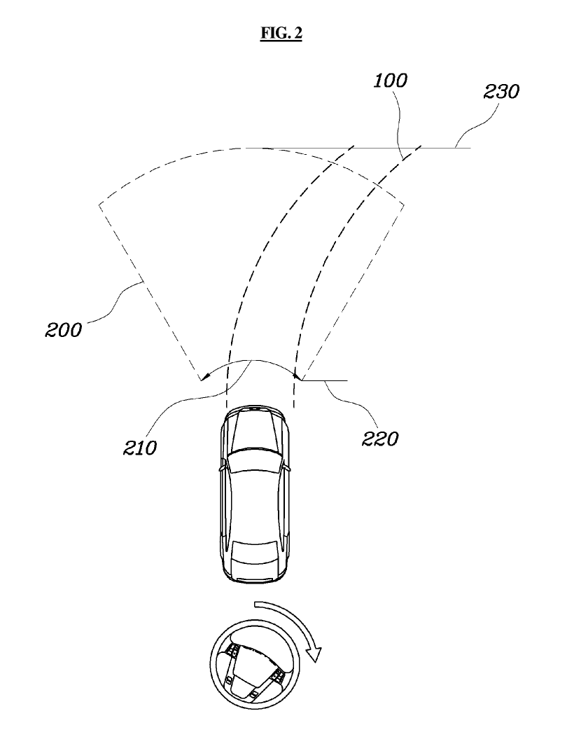

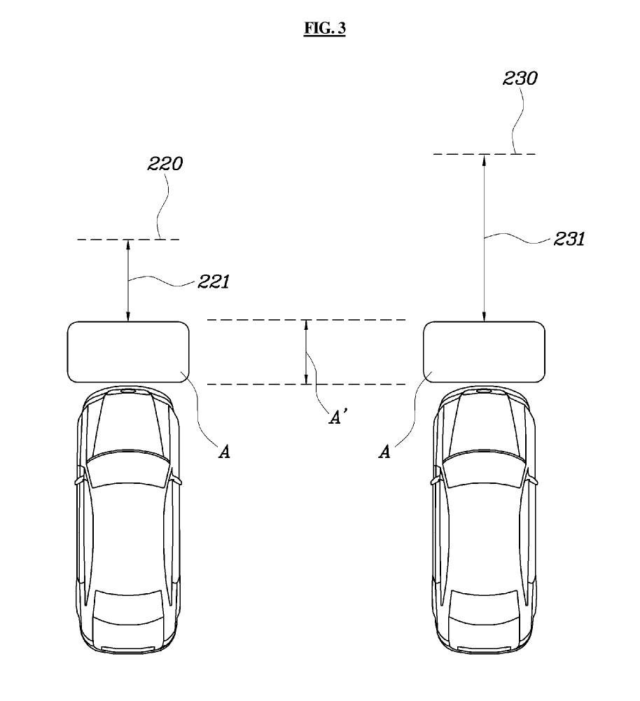

Additionally, the process of setting (S130) the detection area located in front of the vehicle (e.g., a Wide Vehicle Funnel: WVF) may be performed. As shown in FIG. 2, the setting process may include setting, by the controller, a basic area 100 which is moved to correspond with the steering movement of the vehicle, and a real area 200 in which the time of the external airbag of the vehicle and the velocity of the vehicle are considered.

In particular, the basic area may be obtained by calculating a radius of rotation of the vehicle using a vehicle width and a steering angle and by offsetting the radius of rotation to opposite sides of the vehicle. Such a radius of rotation of the vehicle may be derived by the following Equation (1):

$$ρ = \frac{W}{2} \cdot \frac{{W}_{RL} - {W}_{RR}}{{W}_{RL} + {W}_{RR}} , \\ ( calculation of radius of rotation ) \qquad ( 1 )$$

when W denotes the wheel base of the vehicle, and W_{RX} denotes the wheel speed of the vehicle.

Further, the fan-shaped real area may be set based on the relative velocity of the vehicle and the deployment time of the external airbag. In other words, when the time required to fully deploy the external airbag is assumed to be 65 ms, the limit of a minimum real area may be obtained based on the time during which the cushion of the airbag is fully deployed at the minimum relative velocity. When the external airbag is to be deployed at a relative velocity of a minimum of 44 km/h, a separation distance may be calculated at a relative velocity based on a time of 65 ms which is a minimum time required to deploy the external airbag, and the thickness of the airbag may be added to the separation distance, to allow the limit of the real area that must be considered to be a minimum to be obtained. In other words, the minimum value of the real area may be calculated as 1.5 m which is calculated by adding 0.7 m (the thickness of the airbag) to 0.8 m (a distance based on a relative velocity of 44 km/h and a time of 65 ms), that is, 0.7 m+0.8 m.

Further, the maximum value of the real area may be calculated as a value that is obtained by adding 0.7 m (the thickness of the airbag) to 2.9 m (a distance based on a maximum relative velocity of 160 km/h and a time of 65 ms), that is, 0.7 m+2.9 m, when the external airbag is to be deployed in a collision having a maximum relative velocity of 160 km/h.

However, a deployment operation may only be possible in the above situation when a minimum recognition time required by a sensor, such as an imaging device, to identify an object, a time required by the sensor to sample measured values, and a time corresponding to the number of sampling times are additionally secured. Therefore, when the maximum value, 8.9 m, a distance based on an imaging device determination time of 200 ms, and a relative velocity of 160 km/h and 8.9 m, a distance based on a time of 200 ms during which sampling at a sampling time of 40 ms is performed five times, and a relative velocity of 160 km/h, may be additionally required, and as a result, a maximum value of 21.4 m may be required. Therefore, another object may be searched for in an area spaced apart from the front of the vehicle by at least 1.5 m, and then the airbag may be to deployed. Further, another object may be searched for in an area spaced apart from the front of the vehicle by a maximum of 21.4 m, and then the airbag may be deployed.

Thus, other objects may be detected in a range in which the basic area and the real area overlap. When other objects are present both in the basic area and in the detection area, an object closest to the vehicle may be set as a target object. Alternatively, when 10 objects may be tracked in the real area, and 12 objects are detected, a criterion for elimination may be utilized to eliminate other objects detected where the basic area and the real area do not overlap each other.

Moreover, when an object is detected in such a detection area, such the object may be called a detected object at step S140. The physical characteristics of detected objects may be measured by a laser sensor or a radar sensor, and the type of the detected objects may be determined by a imaging device sensor. Further, identifications (IDs) may be assigned to the respective detected objects, and the relative physical characteristics of the detected objects based on the IDs may be sensed and continuously updated.

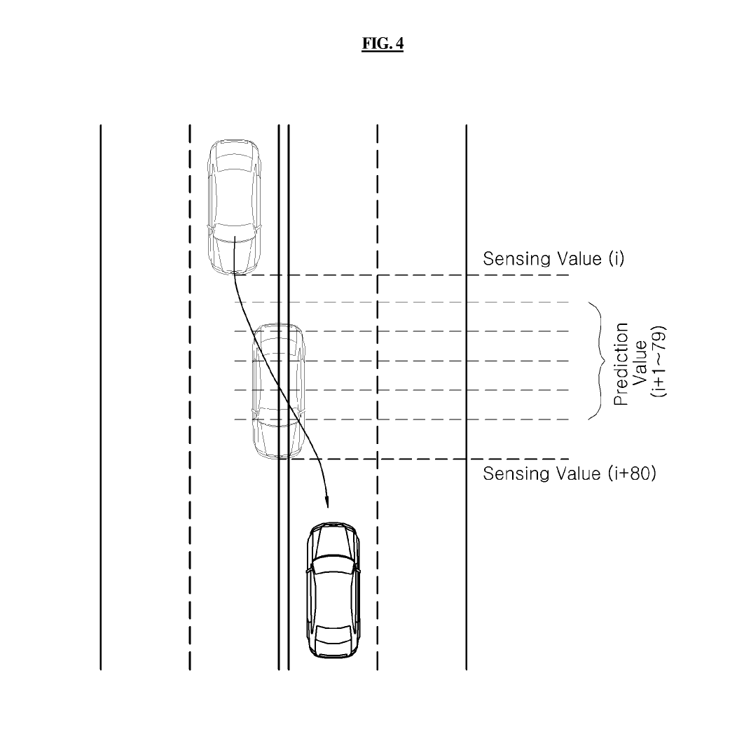

In other words, the setting step may further include recognizing (S210), by the controller, detected objects in the detection area and assigning IDs to the detected objects, and updating (S220), by the controller, detected objects when measurement is performed by a front sensor. Furthermore, the measurement periods of the respective sensors may differ. FIG. 4 is an exemplary diagram showing the prediction procedure of the external airbag deployment method according to an exemplary embodiment of the present invention. In particular, data regarding detected objects and a target object may be updated at intervals of the measurement period of the front sensor, and predicted data may be calculated at intervals of a predetermined time during each measurement period and may be used as data regarding the detected objects and the target object.

In other words, when the measurement period of the sensor is 80 ms, data may not be provided during the measurement period of 80 ms. Therefore, the measured values may be updated at intervals of 80 ms which is the measurement period, additionally updated values may be =predicted at intervals of 1 ms even during the measurement period.

For this operation, as shown in the drawing, when the measurement by the sensor is performed at time i, a value at time i+1 may be obtained using the value obtained at time i. A well-known tracking filter, such as an alpha-beta filter or a Kalman filter may be used to obtain the values. Thereafter, at times ranging from i+1 to i+79, updating may be performed using individual values. This procedure may be understood by the following Equation (2):

\hat{x}ⁱ⁺²=\hat{x}ⁱ⁺¹+ΔT\hat{V}ᵢ₊₁

\hat{V}ᵢ₊₂=\hat{V}ᵢ₊₁ΔTa_{z}, TTE=(\hat{x}ᵢ₊₂−0.7)/\hat{v}ᵢ₊₂ (2)

(ΔT=1 ms,aₛ: Self Vehicle Acceleration)

As described above, a subsequent position may be obtained using a previous position and a previous velocity, and a subsequent velocity may be continuously estimated using current acceleration, that is, acceleration at a time point at which the sensor performs measurement. Since this measurement is performed for a substantially short time (e.g., 80 ms), the range of errors may decrease even when a subsequent velocity is calculated using the current acceleration. Further, time TIE may be obtained by subtracting 0.7 m, that is the thickness of the airbag, from a relative distance and by dividing the subtracted result value by a velocity, at intervals of a predetermined time, that is, 1 MS.

Moreover, the method may further include selecting (S310), by the controller, an object having the shortest Time To EAB (TIE), from the detected objects in the detection area, as a dangerous object (e.g., an object closest to the vehicle), wherein the TTE is the remaining time until the airbag cushion collides with the object when the external airbag is predicted to be deployed. Alternatively, the method may include selecting, by the controller, an object having the shortest Time To Collision (TTC), from the detected objects in the detection area, as a dangerous object, wherein the TTC is the remaining time until the object collides with the vehicle when the vehicle collision is predicted to occur. In other words, from the objects detected in the detection area, an object having the shortest TTE or TTC may be selected as a dangerous object.

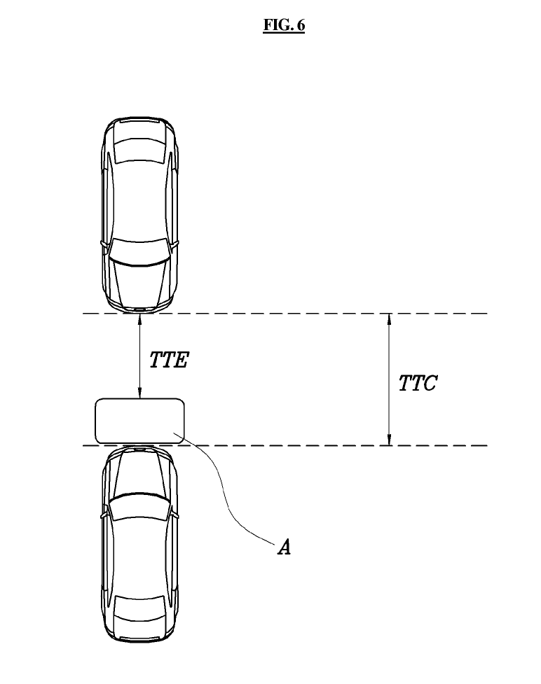

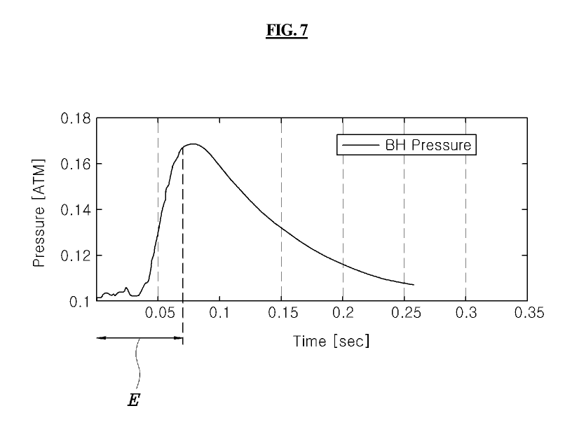

FIGS. 6 and 7 are exemplary diagrams showing TTC and TTE of the external airbag deployment method according to an exemplary embodiment of the present invention. In particular, a TTE denotes the remaining time until an object collides with an airbag cushion at a time when the external airbag is predicted to be deployed, and a TTC denotes the remaining time until the object collides with the vehicle at a time when the vehicle collision is predicted to occur.

In other words, as shown in FIG. 6, when the airbag is predicted to be deployed, a TTE denotes a time during which an object collides with the airbag when the airbag is fully deployed. In particular, as shown in FIG. 7, as time elapses during the deployment of the airbag, the pressure of the cushion may increase, and may be maximized when the airbag is fully deployed, and then decreased after full deployment. To cause the object to collide with the airbag when the airbag is fully deployed, a time TTE is introduced. Therefore, the TTE may be obtained from the distance of the current object, and the maximum shock absorption performance may be obtained when the airbag is caused to be deployed for the obtained time TTE. Moreover, a TTC denotes the remaining time until an object collides with a vehicle bumper, and is a concept frequently utilized in a conventional internal airbag mounted in the vehicle.

Therefore, in an autonomous vehicle, an object having the shortest TIC, which is the remaining time until the object collides with the vehicle when a vehicle collision vehicle is predicted to occur, may be selected from among a plurality of objects detected in the detection area as a dangerous object. Alternatively, an object having the shortest TTE or TIC may be first selected from the objects detected in the detection area as a dangerous object.

Furthermore, as will be described below, the method may include determining whether to deploy the airbag while the dangerous object is being monitored. In other words, when the relative velocity of the dangerous object is greater than a first reference at step S320, an overlap is greater than a second reference at step S330, and a TTE is less than a third reference at step S340, the controller may be configured to select the dangerous object as a target object.

First, the relative velocity of the dangerous object is monitored. Further, the relative velocity may be greater than a minimum of 44 km/h as the first reference since the minimum relative velocity, at which the vehicle must be protected in a collision with the dangerous object, is 44 km/h.

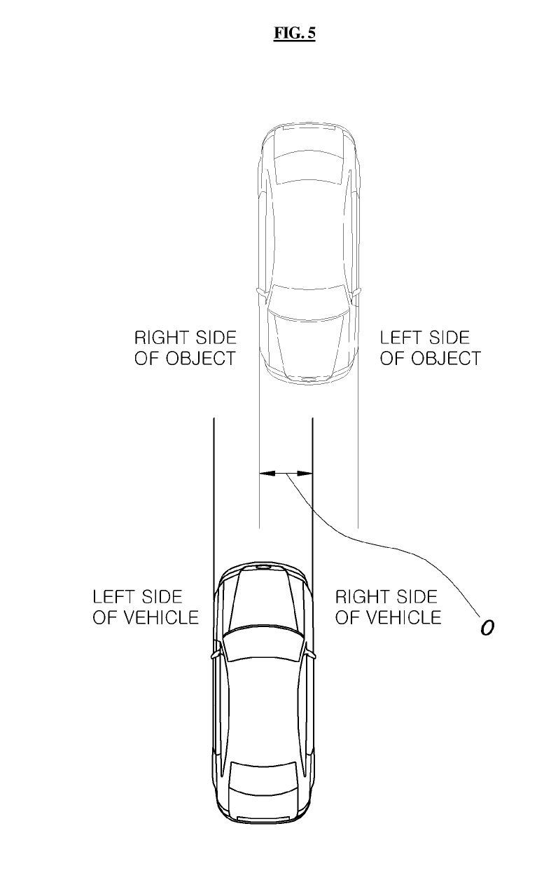

Furthermore, the overlap of the dangerous object with the vehicle may be greater than 20% as the second reference. As shown in FIG. 5, a larger value of the left boundary value of the vehicle and the right boundary value of an object may be selected, and a smaller value of the right boundary value of the vehicle and the left boundary value of the object may be selected. Then, the values between the selected boundary values may be considered to be an overlap distance, and the overlap distance may be divided by the width of the vehicle, and thereafter the divided result value may be multiplied by 100 to be represented as a percentage. Therefore, when an object recognized as the dangerous object has a substantially high relative velocity and a substantially large overlap, the object is selected as the target object.

Furthermore, the dangerous object may be selected as a target object when a TTE is less than the third reference, since when the dangerous object has a substantially high relative velocity, a substantially large overlap, and a substantially short collision time, the dangerous object may have an increased risk of collision.

Moreover, after the above procedure, of the method may further include determining, by the controller, whether the vehicle is stable by comparing the predicted yaw rate of the vehicle with a measured yaw rate. In other words, the controller may be configured to determine whether the driving stability of the autonomous vehicle may be maintained by considering the vehicle to be an object having a two-degree-of-freedom. In particular, when a difference between the actual yaw rate of the vehicle and the predicted yaw rate is greater than a predetermined level, is the controller may be configured to determine that the vehicle is unstable. This technology is frequently utilized in conventional vehicle posture maintenance technology, such as, Electronic Stability Program (ESP) or the like, and thus a detailed description thereof will be omitted here.

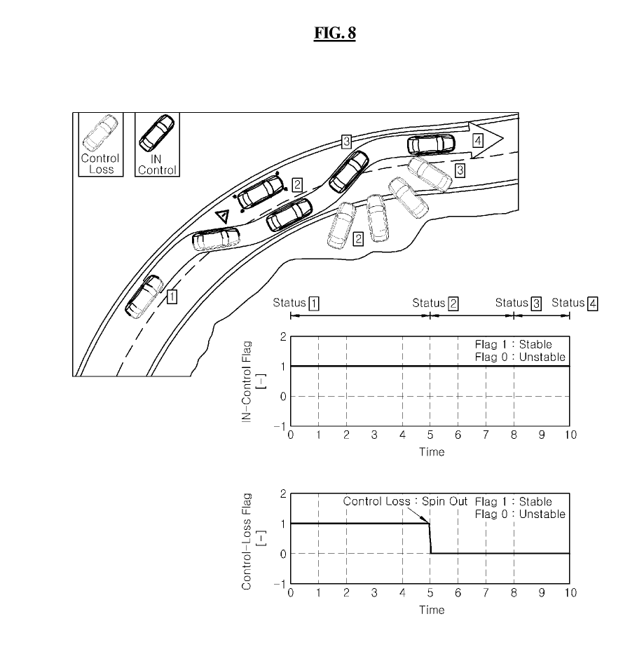

FIG. 8 is an exemplary diagram showing the stability determination step of the external airbag deployment method according to an exemplary embodiment of the present invention. In FIG. 8, flag 1 indicates a state when the vehicle is driven in a condition of maintaining traction stability, and the process proceeds to a situation in which the external airbag may be deployed. When traction stability is lost, as indicated by flag 0 in FIG. 8, the external airbag may not be deployed. Therefore, the external airbag may be deployed during unstable driving conditions.

Thereafter, the steps S410, S420, S430, and S440 of determining whether a relative velocity and an overlap, predicted when a vehicle collision is predicted to occur, are greater than predetermined levels may be performed. Further, the predetermined levels at the prediction step and the deployment step may be the first reference for the relative velocity and may be the second reference for the overlap.

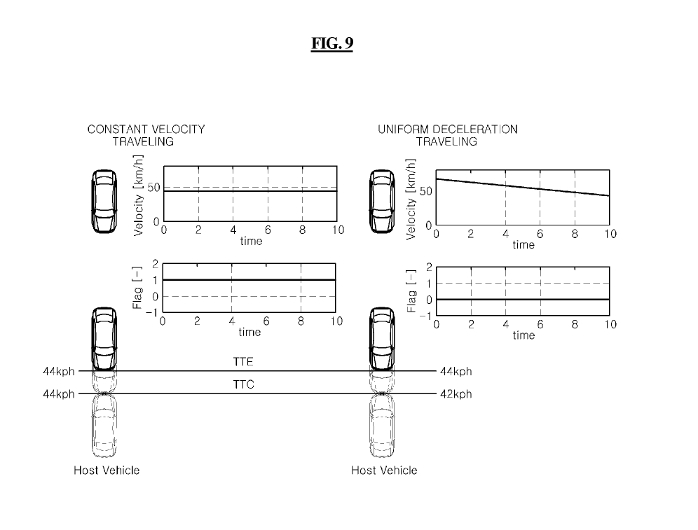

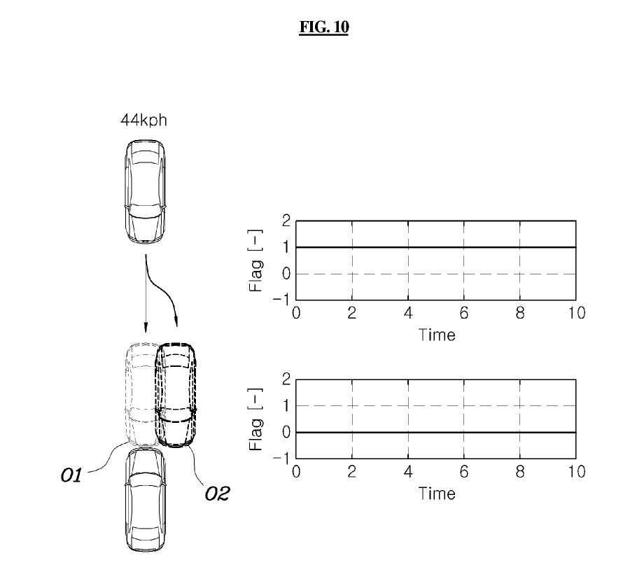

FIGS. 9 and 10 are exemplary diagrams showing the prediction step of the external airbag deployment method according to an exemplary embodiment of the present invention. In FIGS. 9 and 10, when an autonomous vehicle and a target object are traveling at constant velocity, the relative velocity may be maintained to be greater than the first reference. However, when the vehicle and the target object are traveling while decelerating, the velocity may decrease to a velocity of 42 km/h, lower than the first reference (e.g., 44 km/h). Thus, the external airbag need not be deployed.

Therefore, even when the current relative velocity of the target object exceeds a minimum reference value of 44 km/h, when a predicted value at the collision time does not exceed 44 km/h, the airbag may not be deployed. Furthermore, the above situation may be shown by obtaining the mean of relative velocities obtained for a predetermined period of time, dividing the mean by time to obtain a relative acceleration, predicting a relative velocity at a TTC based on the relative acceleration, and then tracking the target object.

Further, when an overlap, as shown in FIG. 10, appearing at a time TTC, that is, at the time of collision, is predicted, and whether an actual collision will occur at an overlap of 20% or more may be predicted. Similarly, an overlap may be predicted by obtaining the mean of lateral relative velocities obtained to a current time, and tracking a lateral relative displacement at a time TTC based on the mean.

Therefore, the present invention may prevent false deployment of the external airbag by preventing the external airbag from being deployed when the relative velocity predicted at a TTC, that is, the time of a collision, does not exceed 44 km/h or when the overlap predicted at a TTC does not exceed 20% even when the current relative velocity exceeds 44 km/h and the current overlap exceeds 20%.

Further, when the predicted relative velocity and the predicted overlap of the target object are greater than the predetermined levels, and collision probability (CP) and a variation in CP are greater than predetermined levels, the external airbag may be deployed at steps S510 and S520. The collision probability (CP) may be defined by the following Equation (3):

$$CP = \frac{1}{TTC} or CP = \frac{Overlap}{TTC} \qquad ( 3 )$$

Therefore, a TTC may be obtained by the above equation, and CP may be obtained by taking a reciprocal of TTC or by multiplying the amount of overlap by the reciprocal of TIC. The actual CP may be considered to be substantially high when the obtained CP exceeds a predetermined value, causing the airbag to be deployed, thus preventing the false deployment of the airbag.

Further, the collision probability may be calculated at intervals of 1 ms, thus when the slope of the rate of a variation in CP is less than a predetermined slope, the airbag may not be deployed, and the false deployment of the airbag may be prevented.

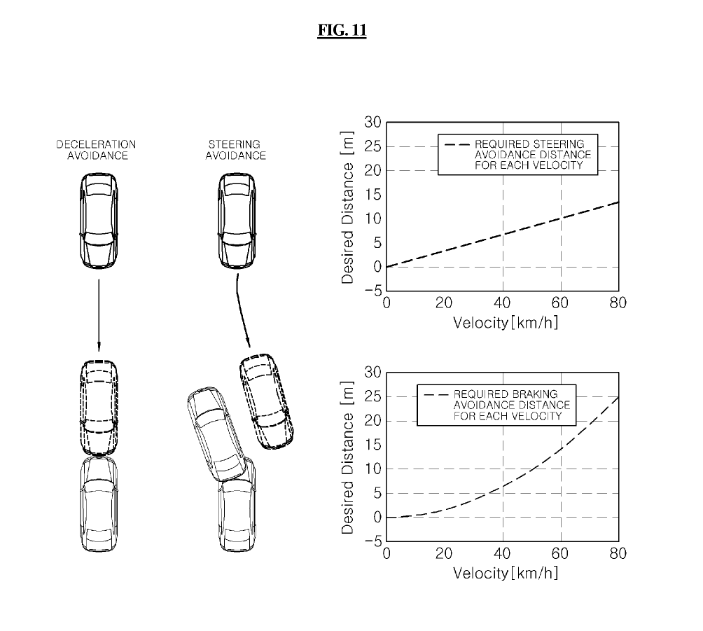

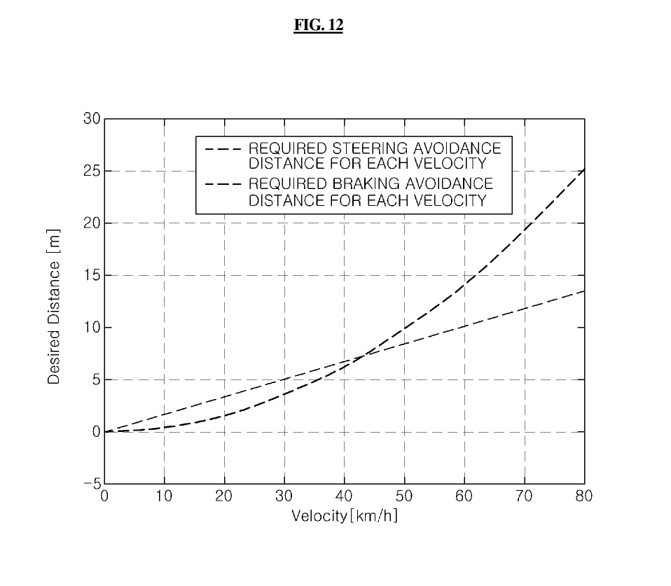

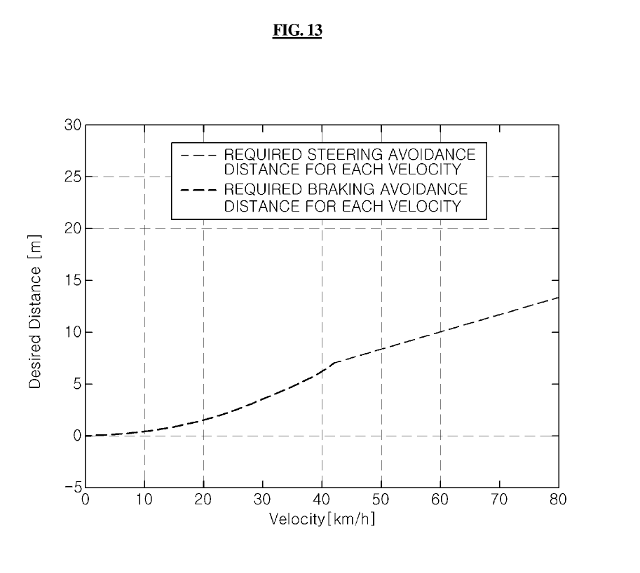

Moreover, when a distance between the vehicle and the target object is less than a required to steering avoidance distance and a required braking avoidance distance, the external airbag can may deployed (that is, Point Of No Return: PONR may be calculated) at step S530 and S540. FIGS. 11 and 13 are exemplary diagrams showing the avoidance step of the external airbag deployment method according to an embodiment of the present invention. In the drawings, a vehicle may avoid a collision using deceleration or steering, which may be represented by a relationship between a relative velocity and a relative distance.

Therefore, respective graphs for a required steering avoidance distance and a required braking avoidance distance versus a relative velocity overlap each other. A portion under a common denominator of the graphs, that is, the curve of the graph of FIG. 13, indicates that when braking or steering is sufficiently conducted, a collision may not be avoided. Thus, the airbag may be deployed.

The required braking avoidance distance may be represented by the following Equation (4):

$${d}_{braking} = \frac{{v}_{0}^{2} - {v}^{2}}{2 {a}_{x}} ( v = 0 , {a}_{x} = 1.0 g ) \qquad ( 4 )$$

This distance denotes a function of dividing a square of the relative velocity by twice the acceleration of gravity g.

Further, the required steering avoidance distance may be represented by the following Equation (5):

$${d}_{steering} = \sqrt{\frac{2 \cdot {o}_{i}}{{a}_{y}}} \cdot {v}_{rel} \\ {o}_{i} = current overlap amount \\ \sqrt{\frac{2 \cdot {o}_{i}}{{a}_{y}}} = time required to avoid current overlap amount ( {o}_{i} ) using {a}_{y} ( 1.0 g ) \qquad ( 5 )$$

The above Equation 5 may calculate the required steering avoidance distance by dividing twice the current overlap amount by a lateral relative velocity, taking a square root of the divided result value, and multiplying the lateral relative velocity by the square root.

Moreover, after this procedure has been performed, of the method may include validating (S560), by the controller, the presence of the target object using an ultrasonic sensor, to prevent sensor errors. Additionally, the method may include checking (S570), by the controller, whether communication and parts are operational, and deploying (S580), by the controller, the external airbag.

The external airbag deployment method according to the present invention will be summarized again below. First, a detection area may be set based on the deployment characteristics of an external airbag, thus reducing the burden of data processing by monitoring selected data regarding actual objects. Further, data may be predicted and calculated during each measurement period of a sensor, to generate data at intervals of 1 ms. After dangerous objects have been selected based on a TIC and a TTE, a corresponding dangerous object may be selected as a target object based on a relative velocity, an overlap, and a TTE, thus specifying and continuously tracking the object in conformity with the actual collision situation of the vehicle.

Furthermore, even when an object is selected as a target object, the target object may be filtered based on a relative velocity and an overlap at a time TTC, thus preventing false deployment, and the target object may be filtered based on collision probability (CP), a variation in CP, vehicle stability, a required steering avoidance distance, and a required braking avoidance distance.

As described above, according to an external airbag deployment method having the above-described configuration, the external airbag may be configured to be deployed after determining the traction stability of a vehicle, physical characteristics at a time when a collision with another vehicle is predicted to occur, collision probability, and avoidance possibility, thus reducing the possibility of false deployment that may deteriorate the characteristics of the external airbag and improving the reliability of an external airbag system.

Although the exemplary embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An external airbag deployment method comprising:
setting, by a controller, a detection area located in front of a vehicle;
selecting, by the controller, a target object from a plurality of objects detected in the detection area by comparing a relative velocity, an overlap, and a Time To External Airbag (EAB) (TTE), which is a remaining time until each object collides with an airbag cushion when an external airbag is predicted to be deployed;
determining, by the controller, whether the vehicle is stable by comparing a predicted yaw rate of the vehicle with a measured yaw rate;
determining, by the controller, whether a relative velocity and an overlap, predicted at a time when the target object is predicted to collide with the vehicle, are greater than predetermined levels; and
deploying, by the controller, the external airbag when the vehicle is stable, and the predicted relative velocity and overlap of the target object are greater than the predetermined levels.

2. The external airbag deployment method of claim 1, wherein selecting the target object includes:
selecting, by the controller, a detected object as the target object when the detected object has a relative velocity greater than a first reference, an overlap greater than a second reference, and a TTE less than a third reference.

3. The external airbag deployment method of claim 2, wherein the predetermined levels are given as the first reference for the relative velocity and as the second reference for the overlap.

4. The external airbag deployment method of claim 3, wherein the first reference is selected from a range between 40 km/h and 50 km/h.

5. The external airbag deployment method of claim 3, wherein the second reference is selected from a range between 10% and 30%.

6. The external airbag deployment method of claim 3, wherein the third reference is selected from a range between 70 ms and 90 ms.

7. The external airbag deployment method of claim 1, wherein determining whether the relative velocity and the overlap are greater than the predetermined levels further includes:
determining, by the controller, whether collision probability based on a reciprocal of a Time To Collision (TIC) and a variation in the collision probability are greater than predetermined levels, wherein the TIC is a remaining time until a collision with the vehicle occurs when the vehicle collision is predicted to occur.

8. The external airbag deployment method of claim 7, wherein deploying the external airbag further includes:
deploying, by the controller, the external airbag when the vehicle is stable, the predicted relative velocity and overlap of the target object are greater than the predetermined levels, and the collision probability and the variation in the collision probability are greater than the predetermined levels.

9. The external airbag deployment method of claim 1, wherein determining whether the relative velocity and the overlap are greater than the predetermined levels further includes:
calculating, by the controller, a required steering avoidance distance and a required braking avoidance distance based on a relative velocity of the target object; and
comparing, by the controller, a distance to the target object with the required steering avoidance distance and the required braking avoidance distance.

10. The external airbag deployment method of claim 9, wherein deploying the external airbag further includes:
deploying, by the controller, the external airbag when the vehicle is stable, the predicted relative velocity and overlap of the target object are greater than the predetermined levels, and the distance to the target object is less than the required steering avoidance distance and the required braking avoidance distance.

11. An external airbag deployment system, comprising:
a controller configured to:
set a detection area located in front of a vehicle;
select a target object from a plurality of objects detected in the detection area by comparing a relative velocity, an overlap, and a Time To External Airbag (EAB) (TTE), which is a remaining time until each object collides with an airbag cushion when an external airbag is predicted to be deployed;
determine whether the vehicle is stable by comparing a predicted yaw rate of the vehicle with a measured yaw rate;
determine whether a relative velocity and an overlap, predicted at a time when the target object is predicted to collide with the vehicle, are greater than predetermined levels; and
deploy the external airbag when the vehicle is stable, and the predicted relative velocity and overlap of the target object are greater than the predetermined levels.

12. The system of claim 11, wherein the controller is further configured to:
select a detected object as the target object when the detected object has a relative velocity greater than a first reference, an overlap greater than a second reference, and a TTE less than a third reference.

13. The system of claim 12, wherein the predetermined levels are given as the first reference for the relative velocity and as the second reference for the overlap.

14. The system of claim 13, wherein the first reference is selected from a range between 40 km/h and 50 km/h.

15. The system of claim 13, wherein the second reference is selected from a range between 10% and 30%.

16. The system of claim 13, wherein the third reference is selected from a range between 70 ms and 90 ms.

17. The system of claim 11, wherein the controller is further configured to:
determine whether collision probability based on a reciprocal of a Time To Collision (TIC) and a variation in the collision probability are greater than predetermined levels, wherein the TTC is a remaining time until a collision with the vehicle occurs when the vehicle collision is predicted to occur.
deploy the external airbag when the vehicle is stable, the predicted relative velocity and overlap of the target object are greater than the predetermined levels, and the collision probability and the variation in the collision probability are greater than the predetermined levels.

18. The system of claim 11, wherein the controller is further configured to:
calculate a required steering avoidance distance and a required braking avoidance distance based on a relative velocity of the target object; and
compare a distance to the target object with the required steering avoidance distance and the required braking avoidance distance.
deploy the external airbag when the vehicle is stable, the predicted relative velocity and overlap of the target object are greater than the predetermined levels, and the distance to the target object is less than the required steering avoidance distance and the required braking avoidance distance.

19. A non-transitory computer readable medium containing program instructions executed by a processor or controller, the computer readable medium comprising:
program instructions that set a detection area located in front of a vehicle;
program instructions that select a target object from a plurality of objects detected in the detection area by comparing a relative velocity, an overlap, and a Time To External Airbag (EAB) (TIE), which is a remaining time until each object collides with an airbag cushion when an external airbag is predicted to be deployed;
program instructions that determine whether the vehicle is stable by comparing a predicted yaw rate of the vehicle with a measured yaw rate;
program instructions that determine whether a relative velocity and an overlap, predicted at a time when the target object is predicted to collide with the vehicle, are greater than predetermined levels; and
program instructions that deploy the external airbag when the vehicle is stable, and the predicted relative velocity and overlap of the target object are greater than the predetermined levels.

20. The non-transitory computer readable medium of claim 19, further comprising:
program instructions that select a detected object as the target object when the detected object has a relative velocity greater than a first reference, an overlap greater than a second reference, and a TTE less than a third reference.
